(19) United States
(12) Patent Application Publication
(10) Pub. No.: US 2016/0084485 A1
(43) Pub. Date: Mar. 24, 2016

(54) Handheld Lighting Assembly

(71) Applicant: Mike Bowcutt, Spokane, WA (US)

(72) Inventor: Mike Bowcutt, Spokane, WA (US)

(21) Appl. No.: 14/490,121

(22) Filed: Sep. 18, 2014

(51) Int. Cl. F21V 21/22; F21L 4/00; F21V 21/40

(52) U.S. Cl. CPC F21V 21/22; F21V 21/406; F21L 4/00

(57) ABSTRACT

A handheld lighting assembly for making a user visible in a darkened environment includes a handle. The handle has a middle portion of the handle slidably coupled to a bottom portion of the handle and a top portion of the handle slidably coupled to the middle portion of the handle such that the handle has a telescopically adjustable length. The handle may be gripped by a user. A housing is coupled to the handle. The housing may be elevated above the user. A plurality of light emitters is coupled to the housing. The light emitters may alert an observer to the presence of the user in a darkened environment. An actuator is coupled to the housing. The actuator is electrically coupled to the light emitters. The actuator selectively actuates and de-actuates the light emitters.

### BACKGROUND OF THE DISCLOSURE

### Field of the Disclosure

The disclosure relates to lighting devices and more particularly pertains to a new lighting device for making a user visible in a darkened environment.

### SUMMARY OF THE DISCLOSURE

An embodiment of the disclosure meets the needs presented above by generally comprising a handle. The handle has a middle portion of the handle slidably coupled to a bottom portion of the handle and a top portion of the handle slidably coupled to the middle portion of the handle such that the handle has a telescopically adjustable length. The handle may be gripped by a user. A housing is coupled to the handle. The housing may be elevated above the user. A plurality of light emitters is coupled to the housing. The light emitters may alert an observer to the presence of the user in a darkened environment. An actuator is coupled to the housing. The actuator is electrically coupled to the light emitters. The actuator selectively actuates and de-actuates the light emitters.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a handheld lighting assembly according to an embodiment of the disclosure.

FIG. 2 is a back view of an embodiment of the disclosure.

FIG. 3 is a left side view of an embodiment of the disclosure.

FIG. 4 is a left side perspective view of an embodiment of the disclosure.

FIG. 5 is an in-use view of an embodiment of the disclosure.

### DESCRIPTION OF THE PREFERRED EMBODIMENT

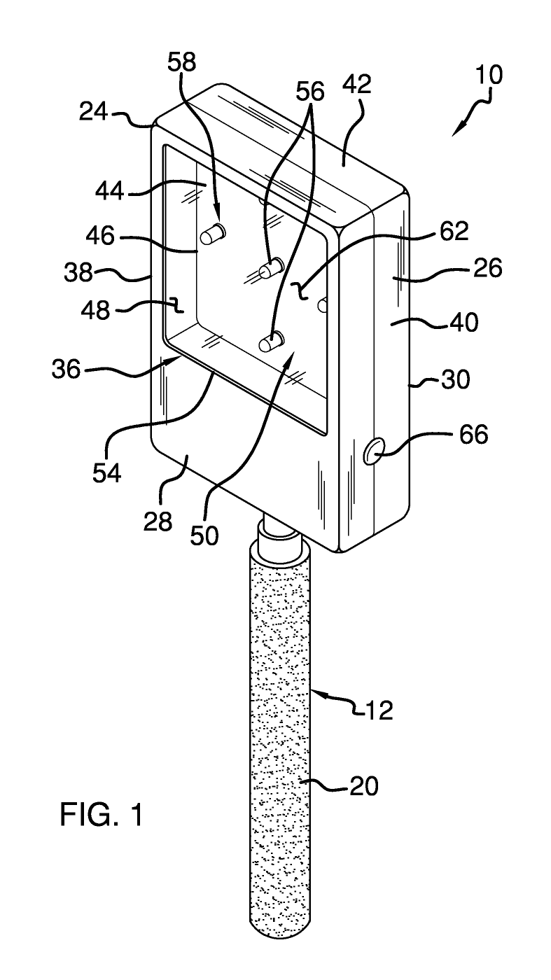

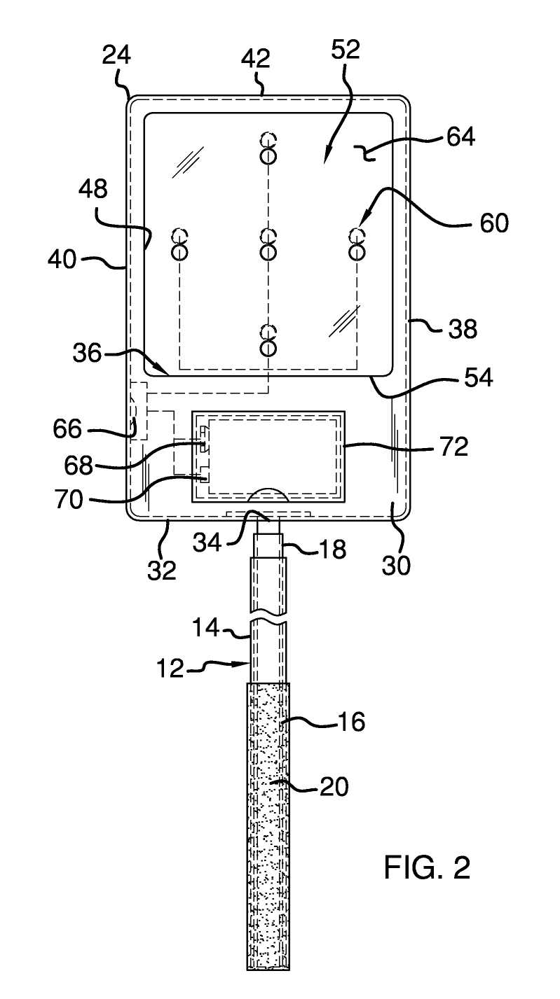

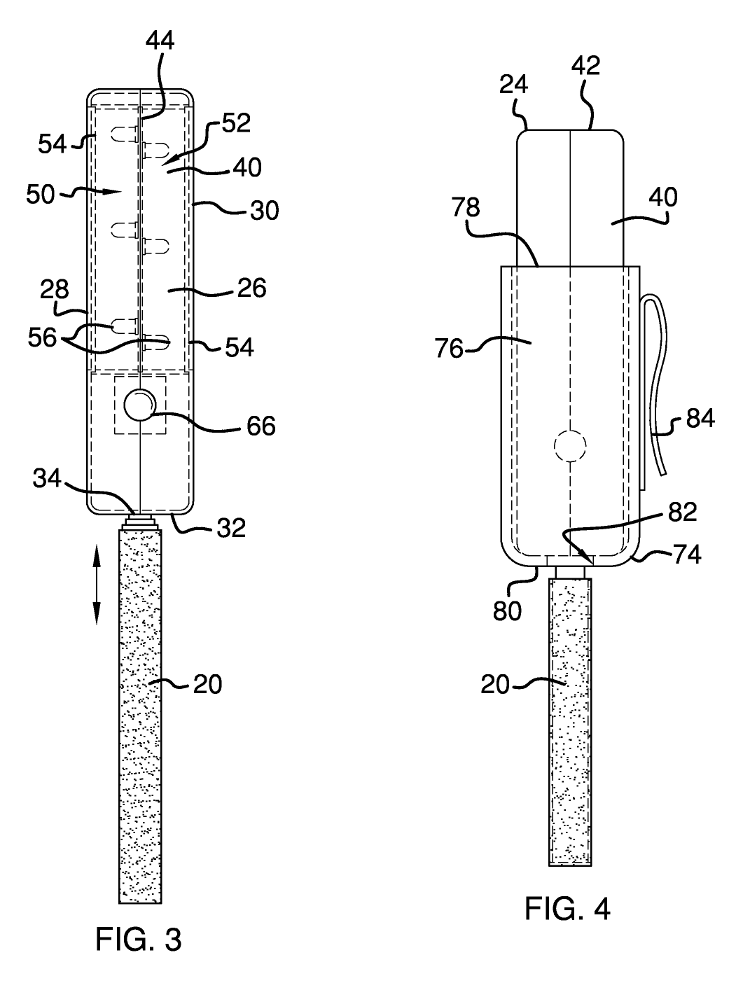

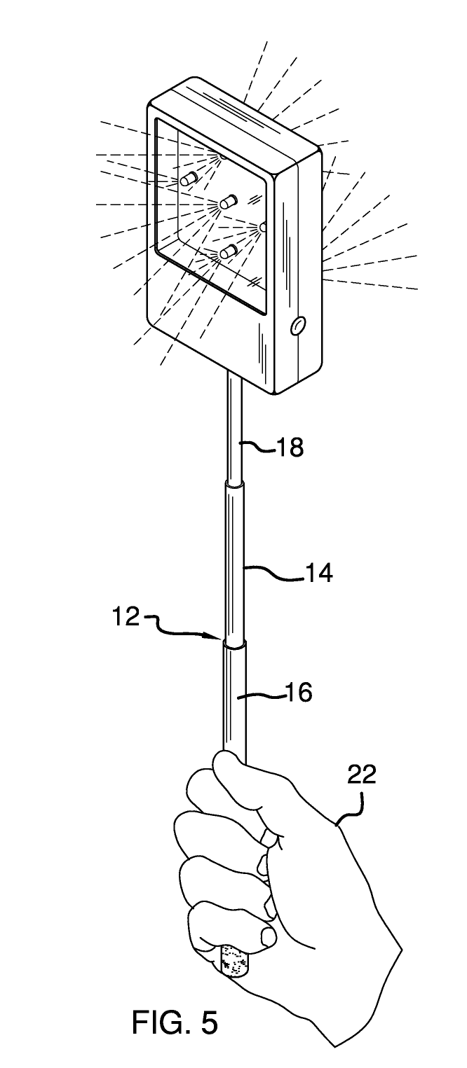

With reference now to the drawings, and in particular to FIGS. 1 through 5 thereof, a new lighting device embodying the principles and concepts of an embodiment of the disclosure and generally designated by the reference numeral 10 will be described.

As best illustrated in FIGS. 1 through 5, the handheld lighting assembly 10 generally comprises a handle 12. The handle 12 has a middle portion 14 of the handle 12 slidably coupled to a bottom portion 16 of the handle 12 and a top portion 18 of the handle 12 slidably coupled to the middle portion 14 of the handle 12. Thus, the handle 12 has a telescopically adjustable length. A grip 20 is coupled to the bottom portion 16 of the handle 12. The grip 20 completely covers the bottom portion 16 of the handle 12. The grip 20 may be gripped by a user 22.

A housing 24 is provided. The housing 24 has an exterior wall 26 extending between each of a front wall 28 and a back wall 30 of the housing 24. A lower side 32 of the exterior wall 26 of the housing 24 is coupled to a top end 34 of the top portion 18 of the handle 12. The housing 24 may be elevated above the user 22 by adjusting the length of the handle 12 wherein the housing 24 is visible to an observer.

The housing 24 has an aperture 36 extending through the front 28 and back 30 walls of the housing 24. The aperture 36 extends between each of a first 38 and a second 40 lateral side of the exterior wall 26 of the housing 24. The aperture 36 further extends from a top side 42 of the exterior wall 26 of the housing 24 toward the lower side 32 of the exterior wall 26 of the housing 24.

A dividing wall 44 is coupled to the housing 24. An outermost edge 46 of the dividing wall 44 is coupled to all four sides of a bounding surface 48 of the aperture 36. The dividing wall 44 divides the aperture 36 into a front portion 50 and a back portion 52. The front 50 and back 52 portions of the aperture 36 are discrete from one another. A pair of windows 54 is provided. Each of the windows 54 is coupled to an associated one of the front 28 and back 30 walls of the housing 24. The windows 54 each completely cover an associated one of the front 50 and back 52 portions of the aperture 36.

A plurality of light emitters 56 is provided. The plurality of light emitters 56 comprises a first set 58 and a second set 60 of the light emitters 56. The light emitters 56 may each be an LED of any conventional design.

The first set of light emitters 58 is coupled to a forward surface 62 of the dividing wall 44. Additionally, the first set of light emitters 58 is positioned within the front portion 50 of the aperture 36. The second set of light emitters 60 is coupled to a rearward surface 64 of the dividing wall 44. The second set of light emitters 60 is positioned within the back portion 52 of the aperture 36. The light emitters 56 emit light outwardly from the front 50 and back 52 portions of the aperture 36.

An actuator 66 is coupled the first lateral side 38 of the exterior wall 26 of the housing 24. The actuator 66 is electrically coupled to the light emitters 56. The actuator 66 selectively actuates and de-actuates the light emitters 56.

A power supply 68 is coupled to the housing 24. The power supply 68 is electrically coupled to the actuator 66. The power supply 68 comprises at least one battery 70. A battery cover 72 is removably coupled to the back wall 30 of the housing 24. The power supply 68 is positioned beneath the battery cover 72.

A holster 74 is provided. The holster 74 has an outermost wall 76 extending between a top end 78 and a bottom end 80 of the holster 74. The top end 78 of the holster 74 is open. The bottom end 80 of the holster 74 has an opening 82 extending therethrough. The housing 24 is positionable in the holster 74 so the handle 12 extends downwardly through the opening 82. A clip 84 is coupled to the outermost wall 76 of the holster 24. The clip 84 may engage the user 22 to retain the holster 74 on the user 22.

In use, the handle 12 is extended to a selected length. The handle 12 is gripped so the housing 24 is elevated above the user 22. The user 22 actuates the light emitters 56 when the user 22 is walking in a darkened environment to alert an observer to the presence of the user 22. The assembly 10 allows the user 22 to more safely walk in the darkened environment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A handheld lighting assembly comprising:
a handle, said handle having a middle portion of said handle slidably coupled to a bottom portion of said handle and a top portion of said handle slidably coupled to said middle portion of said handle such that said handle has a telescopically adjustable length, said handle being configured to be gripped by a user;
a housing coupled to said handle such that said housing is configured to be elevated above the user;
a plurality of light emitters coupled to said housing such that said light emitters are configured to alert an observer to the presence of the user in a darkened environment; and
an actuator coupled to said housing, said actuator being electrically coupled to said light emitters such that said actuator selectively actuates and de-actuates said light emitters.

2. The assembly according to claim 1, further comprising said housing having an exterior wall extending between each of a front wall and a back wall of said housing, a lower side of said exterior wall of said housing being coupled to a top end of said top portion of said handle.

3. The assembly according to claim 2 further comprising said housing having an aperture extending through said front and back walls of said housing, said aperture extending between each of a first and a second lateral side of said exterior wall of said housing, said aperture further extending from a top side of said exterior wall of said housing toward said lower side of said exterior wall of said housing.

4. The assembly according to claim 3, further comprising a dividing wall coupled to said housing, an outermost edge of said dividing wall being coupled to all four sides of a bounding surface of said aperture such that dividing wall divides said aperture into a front portion and a back portion.

5. The assembly according to claim 4, further comprising said plurality of light emitters comprising a first set and a second set of said light emitters, said first set of light emitters being coupled to a forward surface of said dividing wall such that said first set of light emitters is positioned within said front portion of said aperture, said second set of light emitters being coupled to a rearward surface of said dividing wall such that said second set of light emitters is positioned within said back portion of said aperture.

6. The assembly according to claim 1, further comprising a power supply coupled to said housing, said power supply being electrically coupled to said actuator, said power supply comprising at least one battery.

7. A handheld lighting assembly comprising:
a handle, said handle having a middle portion of said handle slidably coupled to a bottom portion of said handle and a top portion of said handle slidably coupled to said middle portion of said handle such that said handle has a telescopically adjustable length, said handle being configured to be gripped by a user;
a housing, said housing having an exterior wall extending between each of a front wall and a back wall of said housing, a lower side of said exterior wall of said housing being coupled to a top end of said top portion of said handle such that said housing is configured to be elevated above the user;
said housing having an aperture extending through said front and back walls of said housing, said aperture extending between each of a first and a second lateral side of said exterior wall of said housing, said aperture further extending from a top side of said exterior wall of said housing toward said lower side of said exterior wall of said housing;
a dividing wall coupled to said housing, an outermost edge of said dividing wall being coupled to all four sides of a bounding surface of said aperture such that dividing wall divides said aperture into a front portion and a back portion;
a plurality of light emitters, said plurality of light emitters comprising a first set and a second set of said light emitters;
said first set of light emitters being coupled to a forward surface of said dividing wall such that said first set of light emitters is positioned within said front portion of said aperture, said second set of light emitters being coupled to a rearward surface of said dividing wall such that said second set of light emitters is positioned within said back portion of said aperture wherein said light emitters are configured to alert an observer to the presence of the user in a darkened environment;
an actuator coupled to said housing, said actuator being electrically coupled to said light emitters such that said actuator selectively actuates and de-actuates said light emitters; and
a power supply coupled to said housing, said power supply being electrically coupled to said actuator, said power supply comprising at least one battery.
